(19) United States
(12) Patent Application Publication
(10) Pub. No.: US 2007/0092700 A1
(43) Pub. Date: Apr. 26, 2007

(54) Embossing and laminating method and device for producing multi-ply web products and relative product

(75) Inventors: Romano Maddaleni, Bientina Pisa (IT); Mauro Gelli, Lucca (IT)

Correspondence Address: BREINER & BREINER, L.L.C., P.O. BOX 19290, ALEXANDRIA, VA, 22320-0290, US

(73) Assignee: Fabio Perini S.p.A., Lucca (IT)

(21) Appl. No.: 10/589,007

(22) PCT Filed: Feb. 7, 2005
(86) PCT No.: PCT/IT05/00056

§ 371 Date: Aug. 10, 2006

(30) Foreign Application Priority Data
Feb. 13, 2004 (IT) FI2004A000032

(51) Int. Cl. B32B 1/00; B32B 37/00

(52) U.S. Cl. 428/174; 156/209; 156/553

(57) ABSTRACT

The embossing and laminating device comprises: a central embossing cylinder (1), provided with a plurality of protuberances (1P); at least three pressure rollers (3, 4, 5) disposed along the periphery of the embossing cylinder (1) and provided with a yielding surface, cooperating with the embossing cylinder; at least three paths to feed one or more plies (V1, V2, V4) between the central embossing cylinder and each pressure roller; at least a first gluing unit (7) disposed between two consecutive pressure rollers and cooperating with said central embossing cylinder.

### TECHNICAL FIELD

The present invention relates to methods and devices for producing embossed web or sheet materials. In particular, although not exclusively, the invention relates to the processing of paper products, for example and specifically tissue paper, such as toilet paper, kitchen towels and the like, with several embossed plies joined together by gluing.

### STATE OF THE ART

Embossing processes are often used in the production of tissue paper manufactures to obtain both technical characteristics and decoration of the finished product. Embossing is implemented with various types of device comprising at least one embossing cylinder, provided with a plurality of projections or protuberances distributed on the surface thereof, and cooperating with a pressure roller, usually provided with a yielding surface, for example made of rubber.

A web material with one or more plies is fed between the embossing cylinder and the pressure roller and is deformed through the effect of the pressure with which the pressure roller and the embossing cylinder are pressed against each other. Deformation, optionally accompanied by at least partial breakage of the fibers composing the material, causes projections or protuberances to form in the web material. Several plies or layers of web material can be embossed separately and joined to each other by gluing, by applying a glue to the protuberances of at least one of the plies and laminating the plies between two cylinders or rollers of the device. In this case reference is made to embossing and lamination and embossing and laminating devices. One or more embossed plies can also be joined by gluing and lamination to one or more smooth plies.

To obtain particular aesthetic and technical-functional characteristics, articles of manufacture with more than three plies joined to one another are produced. Multi-ply products of this type have high levels of strength, softness and absorbent power.

WO-A-9944814 describes various methods and devices for producing embossed and laminated articles. Some of these articles have more than two plies glued to one another. In one example of embodiment described therein (FIG. 3) a product is obtained with three plies, embossed on an embossing cylinder with which two pressure rollers cooperate. Two plies are fed between a first pressure roller and the embossing cylinder, and receive a glue on the protuberances, before a third ply is laid on top of them. The three plies are subsequently embossed and laminated between the same embossing cylinder and a second pressure roller.

EP-A-408248 describes a device in which various embossing or laminating operations are performed on two plies. After joining the two plies to each other, they are fed around an embossing cylinder with which two pressure rollers cooperate.

U.S. Pat. No. 6,589,634 describes a “tip-to-tip” embossing-laminating device. In this two embossing cylinders each cooperate with a respective pressure roller to emboss two plies of paper separately. These receive on the protuberance a glue applied by two glue applicators each cooperating with one of the two embossing cylinders. The glued plies are laminated in a nip defined by the two embossing cylinders, to which a third ply is fed, to obtain a three-ply product.

WO-A-9708386 describes a device for producing an article with two or more plies. In this device, an embossing cylinder cooperates with a first pressure roller to emboss a first sheet composed of two plies, on the protuberances of which a glue is applied. A second sheet is embossed between a second embossing cylinder and a respective pressure roller and subsequently fed to the first embossing roller, where it rests on the glued protuberances of the first sheet.

EP-A-1338412 describes a double embossing-laminating device, comprising a first embossing and laminating unit of the tip-to-tip type, with two embossing cylinders and respective pressure rollers, and a second embossing unit, with a pressure roller and a laminating roller cooperating with a third embossing cylinder. A respective gluing unit is associated with each embossing and laminating unit. This complex machine is intended to form four-ply products.

U.S. Pat. No. 6,599,614 describes an embossing and laminating device of the tip-to-tip type, in which two embossing cylinders each cooperate with a respective pressure roller to separately emboss two plies. These are then laminated to each other, with the interposition of a third ply, in the nip between the two embossing cylinders. Glue can be applied to the tips of the two embossed plies.

A similar device is described in U.S. Pat. No. 5,736,223. In this known device, a gluing unit is provided associated with each of the two embossing cylinders of the tip-to-tip unit. Moreover, the third intermediate ply, which is fed into the nip between the two embossing cylinders, is embossed separately between a third embossing cylinder and a third pressure roller.

U.S. Pat. No. 6,551,691 describes a device for producing an embossed web material with three plies. A first ply is embossed between a first embossing cylinder and a first pressure roller, while a second ply is embossed between a second embossing cylinder and a second pressure roller. The plies thus embossed are joined between the second embossing cylinder and a laminating roller, after interposing of a third ply. A glue is applied to the third ply, that is, the central ply.

U.S. Pat. No. 5,382,464 describes an embossing and laminating device for producing a four-ply material, comprising four embossing cylinders and four pressure rollers. The embossing cylinders are phased to work tip-to-tip. Two glue dispensers, are provided to apply glue to the protuberances of two of the four plies, before reciprocal lamination.

The devices and methods described in the aforesaid documents are often complex and difficult to regulate. Moreover, they are often not sufficiently versatile, that is, they do not allow the type of article produced to be modified.

### OBJECTS AND SUMMARY OF THE INVENTION

The object of the present invention is to provide a device that allows a multi-ply article to be obtained, for example with three or more plies joined together by gluing, which entirely or partly overcomes one or more of the drawbacks of known devices.

According to a different aspect, the object of the invention is to provide an embossing and laminating method which allows articles with a high number of plies, for example three or four, to be produced with a relatively simple machine.

According to yet another different aspect, the object of the invention is to produce a new multi-ply embossed and laminated product.

In substance, according to the invention, an embossing device is provided comprising in combination:
a central embossing cylinder, provided with a plurality of protuberances;
at least three pressure rollers disposed along the periphery of the embossing cylinder and provided with a yielding surface, cooperating with the embossing cylinder;
at least three paths to feed one or more plies between the central embossing cylinder and each of the pressure rollers;
at least one gluing unit disposed between two consecutive pressure rollers and cooperating with said central embossing cylinder.

Preferably, two gluing units are provided cooperating with the central embossing cylinder. In this case, the two gluing units can be inserted between two consecutive pressure rollers, or a first gluing unit can be interposed between two consecutive pressure rollers and the second gluing unit between respective consecutive pressure rollers. With this arrangement, it is possible to obtain embossed and glued products each composed of three or more plies, with easy reciprocal gluing of the plies, thanks to the arrangement of several pressure rollers and of several gluing units around a common embossing cylinder. The pressure rollers emboss and laminate the plies to obtain reciprocal gluing.

When only one gluing unit is provided, the arrangement still allows advantages to be obtained in gluing, thanks to the fact that at least some of the plies are made to pass more than once through a nip between embossing cylinder and pressure roller, consequently facilitating seepage of the glue through one or more plies.

The individual plies can be smooth or one or more (or even each one of them) can be subjected to preliminary processing, to obtain embossing or in any case a raised pattern or an increase in thickness, This can be obtained during production of the ply, using particular papermaker's fabric, with a coarse weft, or by means of preliminary embossing, preferably micro-embossing, that is, embossing with protuberances of a relatively simple form (typically truncated-pyramid shaped) with high density.

For this purpose, according to a particularly advantageous embodiment of the invention, in addition to the central embossing cylinder, the device can have one or more secondary embossing units, each comprising an embossing cylinder and a pressure roller cooperating therewith, to emboss one or more of said plies, disposed upstream of the central embossing cylinder. The plies can be subjected to this preliminary embossing individually, or several plies can simultaneously pass through the same embossing cylinder and pressure roller pair. When several secondary embossing units are provided it is. advantageous for them to impart embossing with different forms and/or dimensions and/or densities on the various plies, to obtain a thicker and more voluminous product, or to reduce the risk of the micro-embossing protuberances of one ply from being inserted into the cavities corresponding to the protuberances of the adjacent ply.

According to a different aspect, the invention relates to a method for producing a web-like product formed of a plurality of embossed plies joined by gluing, comprising the steps of:
feeding at least a first, a second and a third ply to a central embossing cylinder provided with protuberances and cooperating with at least three pressure rollers;
embossing the plies with a common embossing pattern created by said protuberances passing at least the first ply through a nip between the central embossing cylinder and a first pressure roller, at least the first ply and the second ply through a nip between the central embossing cylinder and a second pressure roller and at least the first ply, the second ply and the third ply between a nip between the central embossing cylinder and a third pressure roller;
applying to the projections formed by said protuberances on at least one of said plies a first glue to join said plies to one another.

In a preferred embodiment of the invention, two glues can be applied, to the same ply or to two different plies, by positioning the gluing units between respective pairs of consecutive pressure rollers.

In practice, the glue can be applied to a ply between the first and the second pressure roller and to a further ply between the second and the third pressure roller, although it would, for example, also be possible to provide a single gluing unit between two pressure rollers, or also two gluing units between two pressure rollers, for the purposes which shall be explained in greater detail hereunder. Clearly, it would also be possible to provide more than two gluing units.

According to a particularly advantageous embodiment of the invention, two plies not yet embossed by said central embossing cylinder are fed simultaneously into the nip between one of said pressure rollers and the central embossing cylinder, and are joined by seepage of the glue through at least one of said plies.

According to a further aspect, the invention relates to a web product comprising at least three plies embossed and joined by gluing, wherein said three plies are embossed according to a common embossing pattern, each ply having embossing projections defining said embossing pattern, the projections of each ply being inserted into the corresponding projections of the adjacent ply, and said plies being glued to one another by means of a glue applied to at least some of said projections corresponding with one another in said three plies.

In a practical embodiment, the product can comprise four or more plies. One or more of said plies can be embossed or micro-embossed with a further background pattern, in addition to the common embossing pattern.

The plies can be joined to one another by means of at least one colored glue or by means of two colored glues, optionally with colors differ from each other.

Further advantageous characteristics and embodiments of the device, the method and the product according to the invention are indicated hereunder.

### BRIEF DESCRIPTION OF THE DRAWINGS

The invention will be better understood on the basis of the description hereunder and the accompanying drawings, which show non-limiting examples of embodiments of the invention. More specifically, in the drawing:

FIG. 1 shows a general diagram of an embossing, and laminating device according to the invention;

FIG. 1A shows an enlargement of the detail A of the central embossing cylinder in FIG. 1;

FIGS. 2 and 3 shows schematic and enlarged sections of products obtainable with the device in FIG. 1;

FIG. 4 shows a diagram of a system in which the device in FIG. 1 is inserted;

FIG. 5 shows a diagram of a system in a modified embodiment;

FIGS. 6 shows a device according to the invention in a modified embodiment;

FIG. 7 schematically shows the system in which the device in FIG. 6 is inserted;

FIG. 8 shows a schematic and enlarged section of a product obtained with the system in FIG. 7;

FIG. 9 shows a diagram of a modified embodiment of the device according to the invention;

FIG. 10 shows a diagram of a further variant of embodiment; and

FIGS. 11 to 18 schematically show examples of embodiments of products obtainable with the use of colored glues.

### DETAILED DESCRIPTION OF THE PREFERRED EMBODIMENTS OF THE INVENTION

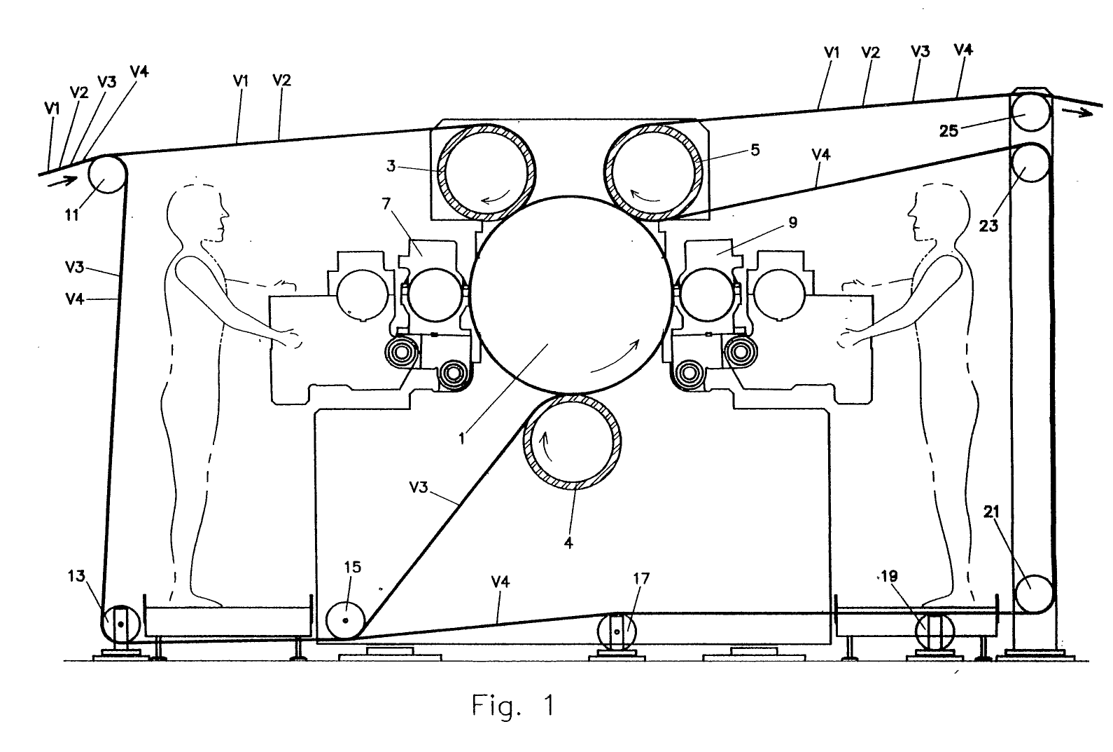

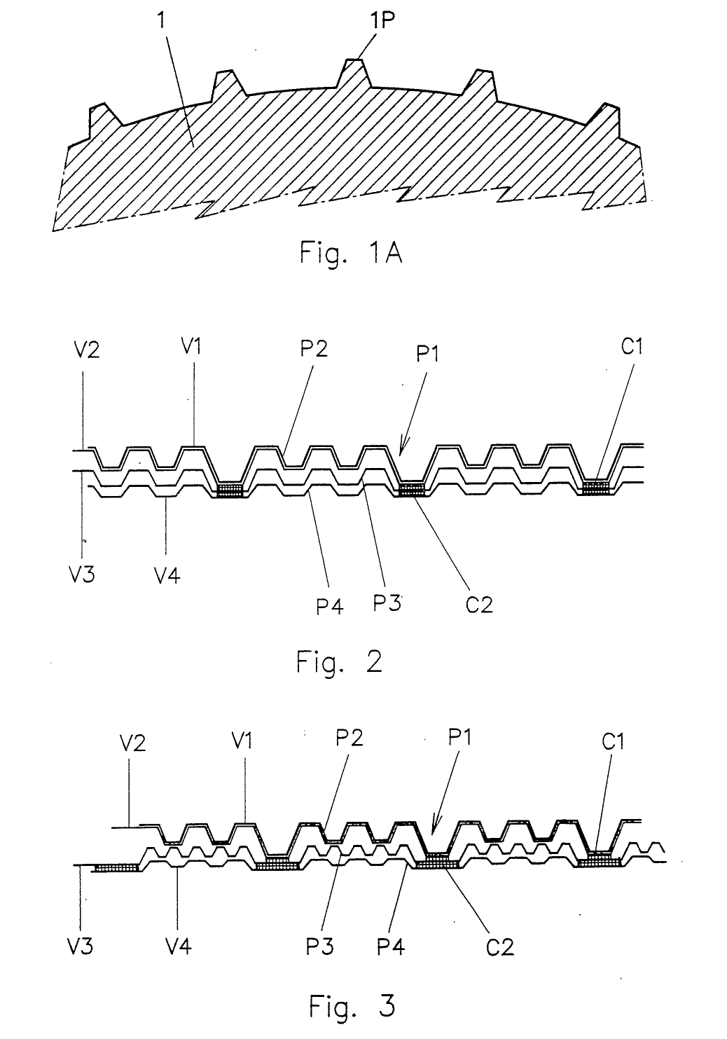

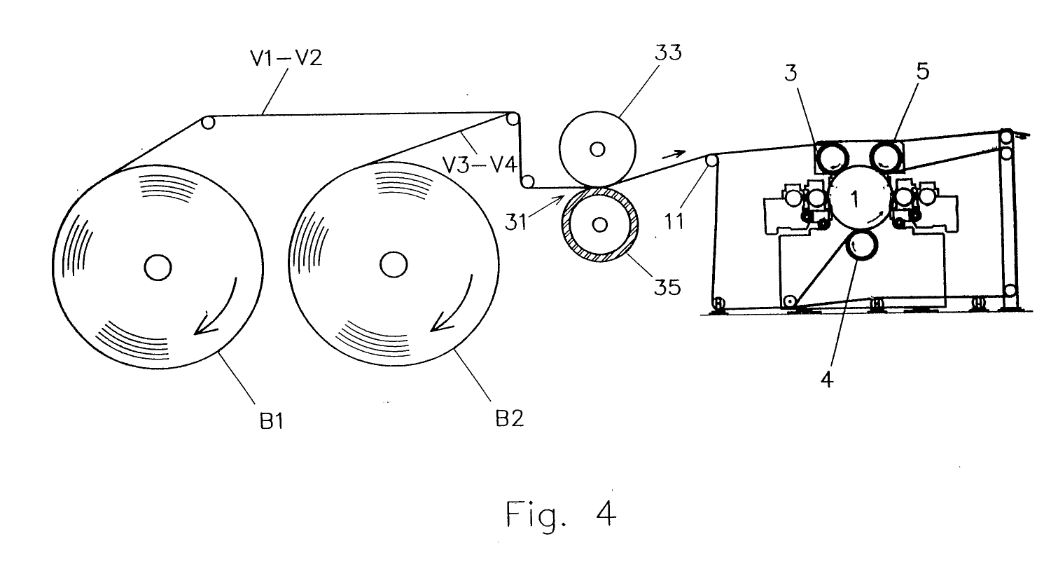

FIGS. 1 and 4 schematically show a first embodiment of the invention. In particular, FIG. 1 shows the embossing-laminating unit comprising a central embossing cylinder 1, around which three pressure rollers, indicated with 3, 4 and 5, are disposed. These pressure rollers can be coated with a yielding material, such as rubber. The hardness of the coating rubber can vary for the three rollers. The central embossing cylinder 1 is provided (FIG. 1A) with protuberances or projections 1P which can have any form. Typically, these protuberances have a form reproducing a pattern which is impressed on the embossed material.

Disposed between the pressure rollers 3 and 4 is a first gluing unit 7, while a second gluing unit 9 is disposed between the pressure rollers 4 and 5. These gluing units can be of any form and are known per se. They are used to apply a glue to the protuberances of the web material fed around the central embossing cylinder 1, or on some of these protuberances. In fact, the protuberances 1P can generally all be of the same height, or of different heights. In the second case only the areas of web material corresponding to the protuberances with a greater height will be glued, while the others will remain without glue. Moreover, the rollers of the gluing units can be produced to apply the glue continuously or in areas.

The diagram in FIG. 1 also shows return rollers 11, 13, 15, 17, 19, 21, 23, which define the paths for the web material. More specifically, a first path is defined to feed one or more plies towards the pressure roller 3, and between it and the central embossing cylinder 1. A second path (rollers 11, 13, 15) is defined to feed one or more plies between the second pressure roller 4 and the central embossing cylinder 1, while a third path (rollers 11, 13, 15, 17, 19, 21, 23) is defined to feed one or more plies towards a third pressure roller 5, between this and the central embossing cylinder 1. A guide roller, at the outlet of the embossing-laminating unit, is indicated with 25.

As can be seen in the overall diagram in FIG. 4, in a first example of embodiment, four plies, indicated with V1, V2, V3 and V4, are fed to the central embossing cylinder 1. Each ply is composed of a ply of tissue paper, for example with a weight per unit of surface ranging from 15 to 30 g/m².

These plies are delivered from two reels B1, B2 each of which is composed of two wound plies. It would also be possible to use reels with a single ply, for example four reels with a single ply, or two reels with a single ply and one reel with a double ply. As schematized in FIG. 4, before reaching the return roller 11, the four plies V1, V2, V3, V4 are combined and fed through a simple secondary embossing unit, indicated with 31, comprising an embossing cylinder 33 provided with protuberances and a pressure roller 35 provided with a yielding surface, for example, coated in rubber. The density of the protuberances of the cylinder 33 is very high, for example greater than 15 protuberances/cm² and preferably equal to or greater than 30 protuberances/cm² and even more preferably equal to or greater than 40 protuberances/cm². These protuberances have a simple geometric form, for example, frusto-pyramidal or frusto-conical shaped. They provide a background pattern on the product, which is impressed by embossing on all four plies V1-V4. The main object of this pattern is to impart technical characteristics of thickness, softness and absorbing capability on the finished product.

The four plies V1-V4 micro-embossed by the secondary embossing unit 31 are then divided as represented in detail in FIG. 1 to be fed to the central embossing cylinder 1 as follows: the two plies V1 and V2 are fed together between the pressure roller 3 and the embossing cylinder 1; the plies V2 and V3 are fed to the return roller 13 and subsequently to the return roller 15 and from here are divided and fed separately to the pressure roller 4 and the pressure roller 5.

The plies V1 and V2 are embossed together by the points or protuberances 1P of the embossing cylinder 1 through the effect of pressure applied by. the pressure roller 3. Protuberances are thereby formed thereon, the tips of which receive a glue from the gluing unit 7, while the plies are still engaged with the protuberances 1P of the embossing cylinder 1. The third ply V3 is laid on the plies and pressed, by means of the pressure roller 4. The pressure of the roller 4 causes embossing of the ply V3 and lamination thereof with the plies V1 and V2. This causes reciprocal gluing of the plies V2 and V3 through the effect of the glue C1 (FIG. 2) applied by the gluing unit 7. Part of the glue C1 seeps through the ply V2 and glues the ply V2 and the ply V1 together.

The tips of the protuberances on the ply V3 are wet with a second glue C2 (FIG. 2) applied by the second gluing unit 9, while the plies V1, V2 and V3 are still engaged on the protuberances 1P of the central embossing cylinder 1. They then pass between the pressure roller 5 and the central embossing cylinder 1 after the ply V4 has been placed on them. This causes on the one hand embossing of the ply V4 and on the other lamination between the plies V1, V2, V3 and the ply V4, with reciprocal gluing of the plies.

The product obtained is represented schematically in the enlargement in FIG. 2. The four plies V1-V4 are all provided with protuberances P1, produced by the projections or protuberances 1P of the central embossing cylinder 1. The protuberances P1 of the four plies are nested inside each other and the glues C1, C2 applied thereon in the way described cause reciprocal adhesion of the plies. The micro-embossing protuberances imparted on the plies V1 and V2 by the secondary embossing unit 31 are indicated with P2. Analogous micro-embossing protuberances, indicated with P3 and P4, have been imparted by the same micro-embossing unit 31 on the plies V3 and V4.

The embossing depth obtained with the three pressure rollers 3, 4, 5 can be variable by appropriately choosing the hardness of the coating in rubber (or another yielding material) of these rollers and/or the pressure with which they are pressed against the central embossing cylinder 1. Moreover, the glues C1 and C2 can be colorless, or one or other or both can be colored, optionally with different colors or different shades of the same color. In this way a further variable is obtained on the possibility of decorating the product. By using one colored and one colorless glue, the product will have colored embossed patterns on one of the two sides (the one nearest to the colored glue). By applying two colored glues of different colors or different shades, a product will be obtained in which the embossed patterns produced by the embossing cylinder 1 with the protuberances 1P are colored on both sides, optionally with different colors or shades on the two sides.

Alternatively or in addition to the colored glue, one or more of the plies V1-V4 can be printed and/or one or more of said plies can be colored by means of a dye added to the pulp of cellulose fibers or the like with which it is produced.

FIGS. 3 and 5 show an embodiment modified to obtain a greater thickness in the finished product with reduction of the risk of the micro-embossing protuberances nesting inside one another.

In this embodiment, instead of one secondary embossing or micro-embossing unit 31, three separate secondary embossing or micro-embossing units 31, 37 and 39 are provided (FIG. 5). The first secondary embossing unit 31 again has an embossing cylinder 33 and a pressure roller 35, to emboss together the two plies V1 and V2 delivered from the reel B1 (or from two separate parallel reels, each with a single ply). The two plies V3 and V4 delivered from the reel B2 (or alternatively from two separate single-ply reels) are fed separately to the two secondary embossing units 37 and 39, each comprising a respective embossing cylinder 41, 45 and a respective pressure roller 43, 47. The three secondary embossing units 31, 37, 39 are essentially the same, except for the fact that the density (and optionally the dimension and/or the form) of the protuberances on the three embossing cylinders 33, 41, 45 differs for the three cylinders. Downstream of the secondary embossing units the four plies are reunited and guided around the roller 11, downstream of which the arrangement is essentially the same as the one described with reference to FIG. 1.

The product which is obtained with this configuration is shown schematically in FIG. 3. It differs from the product in FIG. 2 owing to the different density and dimension of the micro-embossing protuberances P2, P3 and P4. These can have variable densities, for example, ranging from 15 to 200 protuberances/cm² and preferably from 30 to 150 protuberances/cm² and even more preferably from 35 to 90 protuberances/cm², differing for the various plies.

The different density and/or the, different form, dimension or arrangement of the micro-embossing protuberances avoids nesting of the protuberances of one ply into the corresponding cavities of the protuberances of an adjacent ply.

Also in this configuration, printed and/or colored plies and/or colored or colorless glues can clearly be used.

Instead of three micro-embossing units, four units can be used to emboss the four plies separately. Moreover, notwithstanding the number of micro-embossing units, it must be understood that they can be arranged to produce protuberances on one or on the other side of the respective ply or plies, for example, by ensuring that the protuberances produced on two adjacent plies are facing each other, that is they are opposed rather than concordant as shown in these specific examples.

The device according to the invention can also produce articles with three plies, for example, by eliminating one of the two plies V1 or V2. Alternatively, it can also produce manufactures with more than four plies, by feeding two plies together to one or other of the pressure rollers 4 and 5. In any case the plies can optionally be separated and micro-embossed separately and subsequently, recombined to be fed to pairs of pressure rollers. In the examples described with reference to FIGS. 1 to 5 the plies V1 and V2 could also undergo separate preliminary micro-embossing by means of two separate secondary embossing units, to obtain different densities, dimensions or forms of the micro-embossing protuberances on the two plies.

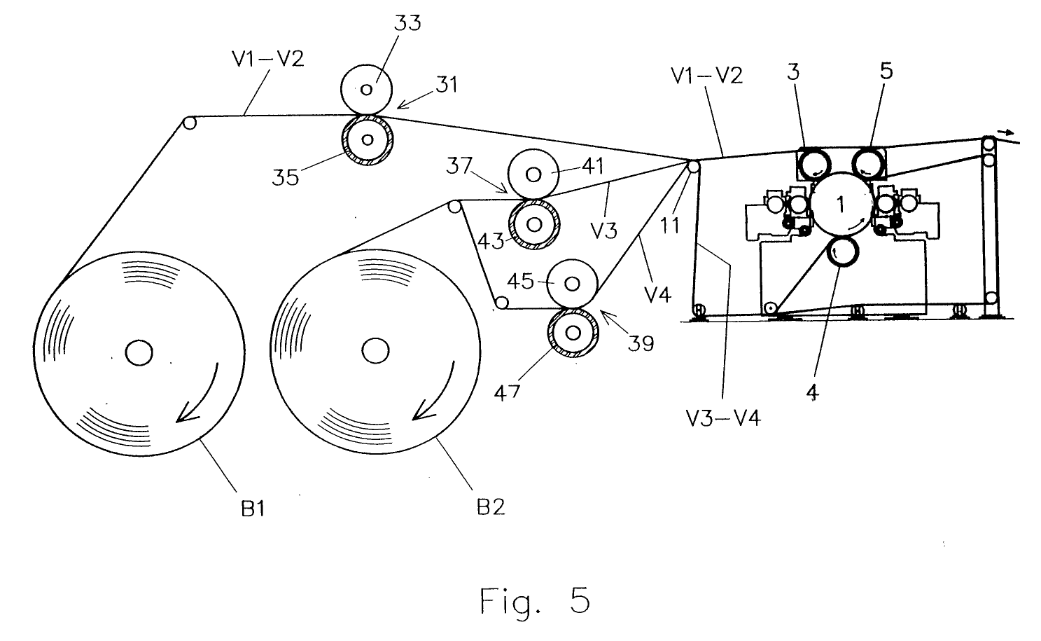

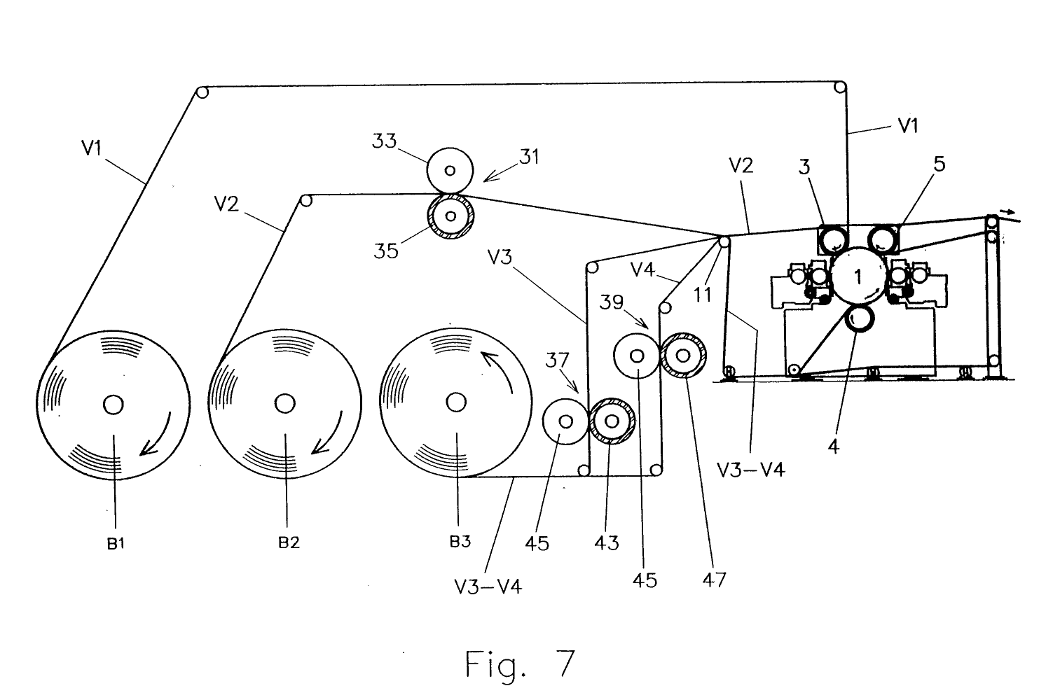

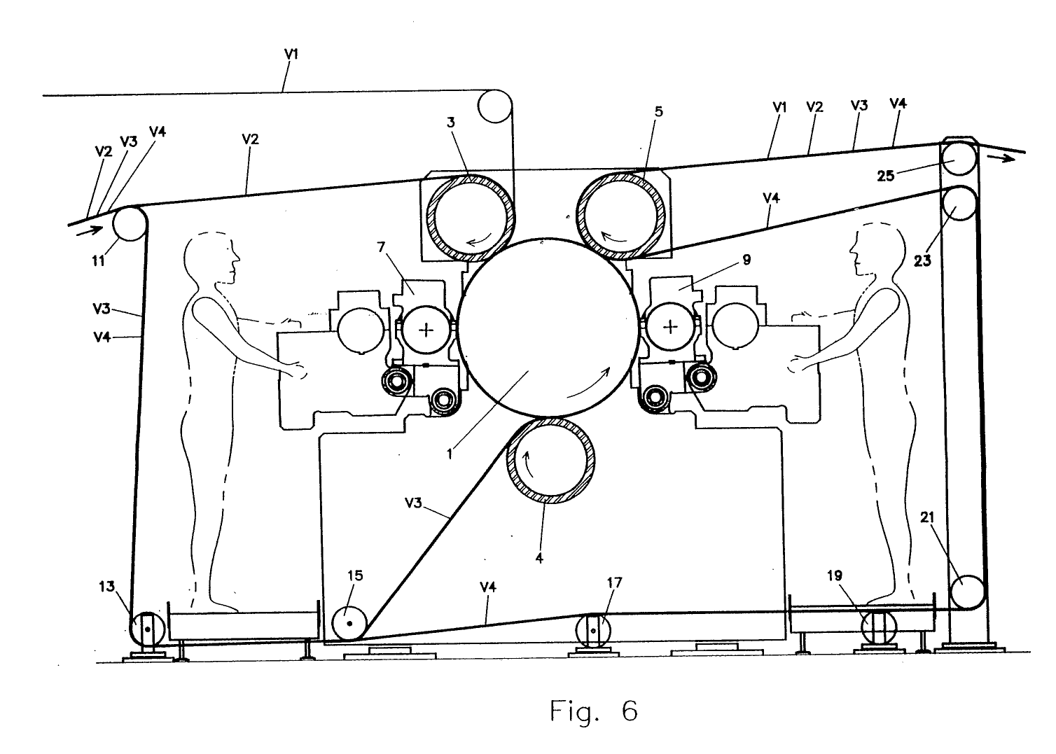

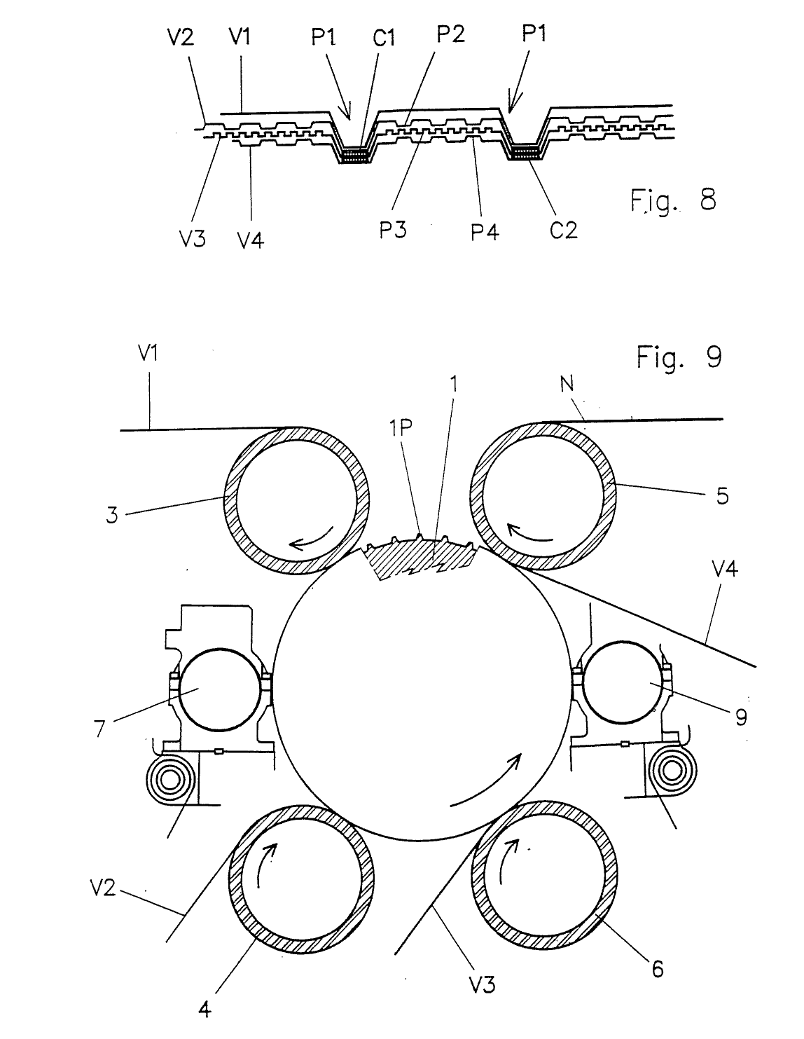

Alternatively, one or more of the plies might not undergo preliminary micro-embossing. An embodiment of this type is shown in FIGS. 6 to 8. The same references indicate the same or equivalent parts to those in the previous embodiments. In this example, the ply V1 is not micro-embossed before being fed (separately with respect to the ply V2) into the nip formed between the central embossing cylinder 1 and the pressure roller 3. As can be seen in the schematic section in FIG. 8, the ply V1 is in this way only embossed with the pattern formed by the protuberances P1 produced by the protuberances or projections 1P, while the plies V2, V3 and V4 are also micro-embossed with protuberances P2, P3 and P4.

As can be seen in FIG. 7, the plies are in this case fed from three reels: the reel BI with a single ply feeds the ply V1, the second reel B2 with a single ply feeds the ply V2, while the reel B3 with a double ply feeds the plies V3 and V4. This is in consideration of the variation in length of the plies imposed by embossing. Feed of the ply V1 from a reel B1 with a single ply allows a different unwinding speed with respect to the unwinding speed of the ply V2 from the reel B2, also with a single ply. This makes it possible to allow for the effects of modification of the length of the paper caused by embossing on one but not on the other of the two plies.

As in the previous embodiments, here too printing, colored glues and coloring of the pulp can be used (in combination or alternatively).

It must be understood that with the device described it is possible to produce a plurality or products, activating or deactivating the secondary embossing units and/or modifying the path of the plies, combining several plies, or using different colors. In particular, although FIG. 8 represents a product with only one ply (the ply V1) which is not provided with pre-embossing or micro-embossing, and that this is the external ply, it would also be possible to feed one or more smooth plies, that is, without preliminary embossing or micro-embossing, destined to remain on the inside the finished product. Moreover, a double ply could be fed not only to the first pressure roller 3, but also to one, to the other or to both the rollers 4 and 5, only to the roller 4, or only to the roller 5, or only to the rollers 4 and 5 but not to the roller 3.

FIG. 9 shows a variant of embodiment in a view similar to the one in

FIGS. 1 and 6, but limited to the embossing cylinder and to the members surrounding it. The same references indicate the same or equivalent parts to those in the previous examples of embodiment. In this case, four pressure rollers, indicated with 3, 4, 5 and 6, are disposed around the embossing cylinder 1, provided with protuberances 1P. A first gluing unit 7 is disposed between the roller 3 and the roller 4, while a second gluing unit 9 is disposed between the pressure rollers 6 and 5. No gluing unit is interposed between the rollers 4 and 6. The embossing device thus configured is fed with four plies V1, V2, V3, V4, each fed around a respective pressure roller 3, 4, 6 and 5. Each ply V1-V4 could in turn be single or multiple and optionally previously subjected to micro-embossing as shown in the previous examples of embodiment.

The embodiment in FIG. 10, on the other hand, has an embossing unit with a central embossing cylinder 1, three pressure rollers 3, 4 and 5 and two gluing units 7 and 9, but in this case the two gluing units are disposed between two consecutive pressure rollers 3 and 4, while no glue is applied between the consecutive rollers 4 and 5. This configuration is particularly useful if colored glues with different colors and cliché gluing units are used, as shall be explained in greater detail hereunder. The gluing unit 9 is indicated with a dashed line, as it would also be possible to produce an embossing device with a central embossing cylinder, three pressure rollers and only one gluing unit 7.

More complex combinations would also be possible, such as a configuration as shown in FIG. 9 with a third gluing unit between the rollers 4 and 6.

In the various examples shown in which two (or optionally more than two) gluing units are used, these can be fed with colored glues of different colors or different shades of the same color In this case, one or more of the gluing units could also be provided with a cliché gluing roller, which distributes glue in areas rather than uniformly. By producing the gluing roller with a circumferential development equal to a multiple of the circumferential extension of the embossing cylinder 1 and by phasing the protuberances 1P of the cylinder 1 with the pattern of the cliché of each of the cliché gluing rollers particular effects can be obtained.

Examples of these effects are shown with reference to FIGS. 11 to 14. FIG. 11 schematically shows a front view of a portion of a web material N formed of several plies embossed with one of the devices described above. The material N has a decoration obtained by embossing composed of a repetition of two different series of protuberances, PA and PB, exemplificatively representing suns and clouds. Using two gluing units 7 and 9 with cliché gluing rollers, it is possible to ensure that all the protuberances PA are glued with a glue of one color and all the protuberances PB with a glue of a different color. This is possible as the cliché of the gluing unit that glues the protuberances PA does not touch the protuberances PB and vice versa. By operating in this way a product with complex colored decorations can be obtained without the use of a printing unit.

The material N can be composed of a variable number of plies and the two glues can be applied to two different plies, for example with an arrangement as shown in FIG. 1, or to the same ply, for example with an arrangement as shown in FIG. 9.

FIG. 12 schematically shows a section of the article N produced with three plies V1, V2 and V3. The glue C1 is applied to the ply V1, while the glue C2 is applied to the ply V2. Each of the plies V1, V2 and V3 can clearly either by single or multiple, for example double and optionally one or more of said plies can be subjected to further processing, such as micro-embossing, as described above.

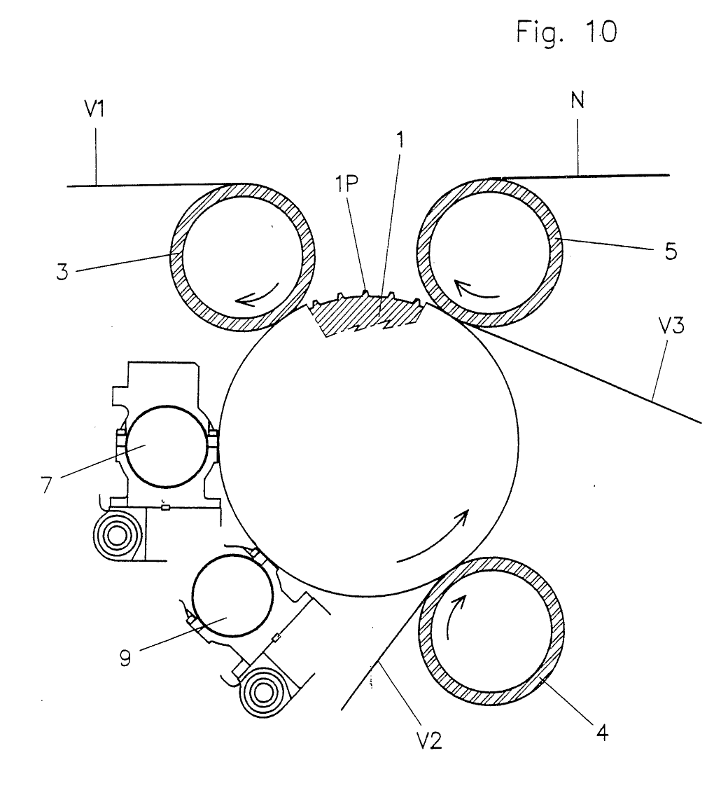

FIG. 13 schematically shows a local section of a similar web material N, but obtained for example with a configuration of the type described in FIG. 10, that is, by applying two glues C1 and C2 of different colors to the ply V1. The pressure exerted by the rollers 4 and 5 is sufficient to make at least part of the glue seep between the plies V2 and V3 to also obtain adhesion of the ply V3 to the ply V2.

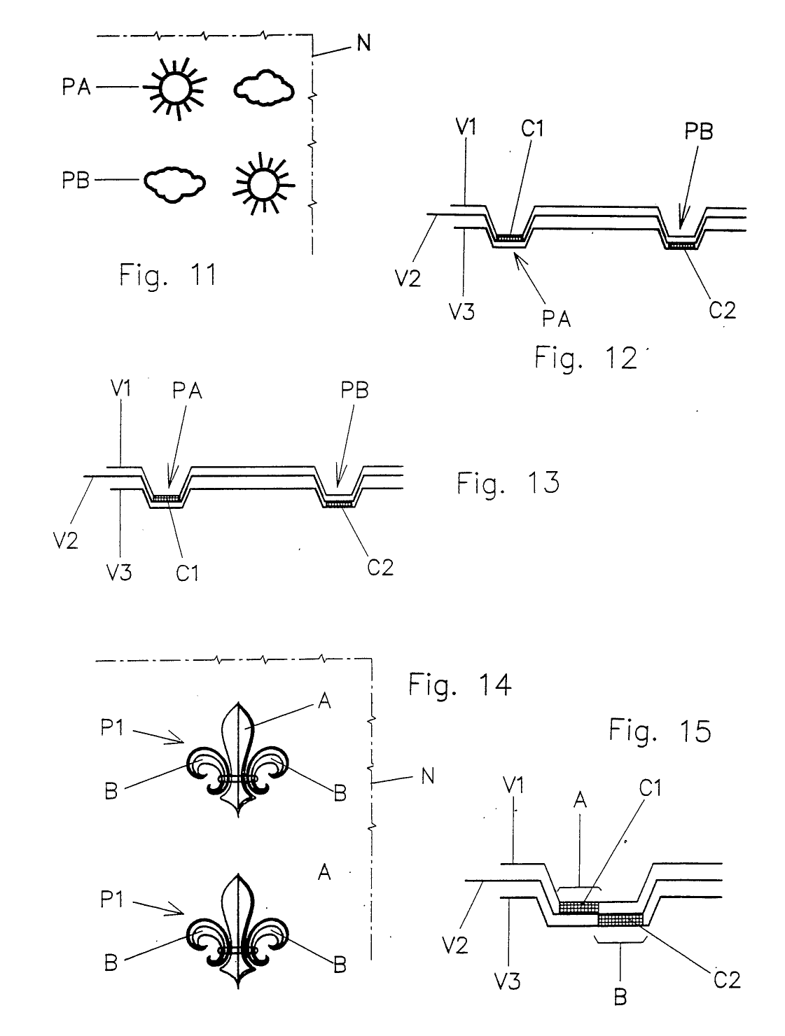

FIG. 14 shows a front view of a portion of a different web material N obtainable with the use of glues of different colors. In this example, the decorative protuberances obtained by embossing the plies V1-Vn are in the form of floral patterns formed of two portions indicated with A and B of different colors (in the example a flower with a stem).

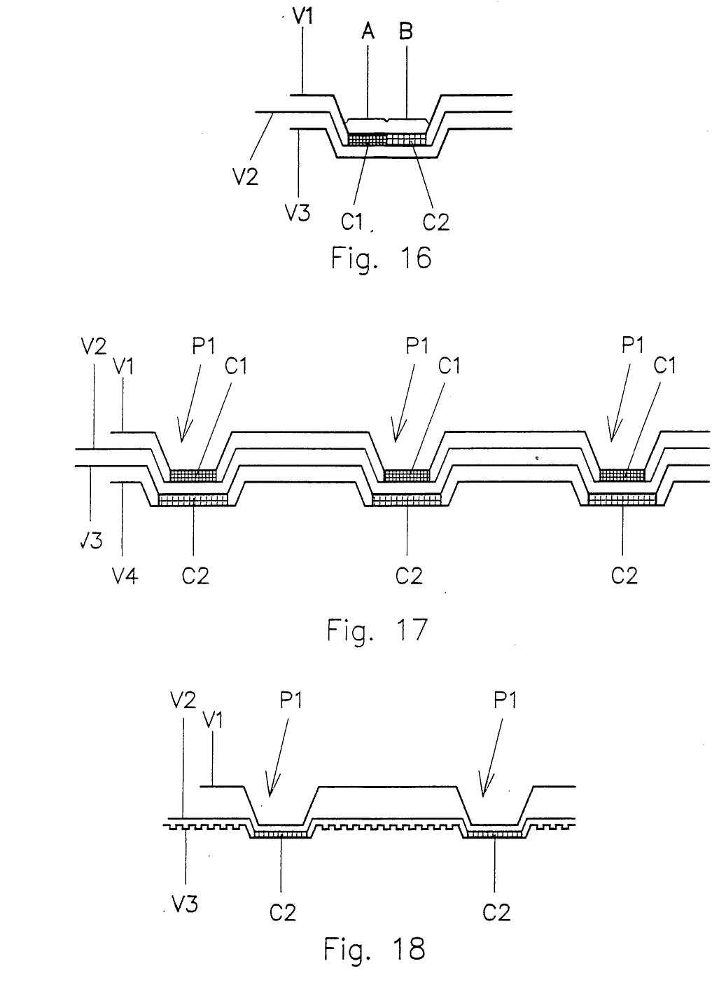

FIGS. 15 and 16 show enlarged and greatly schematized cross sections of the product obtained with three plies V1, V2, V3. The two areas A and B of each single protuberance P1 are glued with glues C1 and C2, of different colors. In the case in FIG. 15 the two glues C1 and C2 are applied, as in the example in FIG. 12, to two separate plies (V1 and V2), while in the example in FIG. 16, the two glues are applied in the two areas A and B of the same ply V1.

By extending the concepts described it is clearly possible to obtain numerous effects, even very complex.

With only two glues of two different colors, it is also possible to obtain patterns with three colors, by at least partly superimposing the glues to produce a third color. For example, blue and yellow glues can be applied with cliché rollers with common application areas, where the combination of the two colored glues produces a green color.

In another development of the invention, the two or more colored glues and the plies can be combined with one another, to produce a web material with decorations which have two different colors on the two sides. A schematic example is represented in FIG. 17. This product is produced with four plies V1, V2, V3 and V4. A glue C1 is applied to all the protuberances of the ply V1, while a glue C2 of a different color is applied to all the protuberances of the ply V3.

The plies V2 and V3 separate the areas of glue C1 and C2 sufficiently to show two different colors on the two sides. To improve separation of the chromatic effect on the two sides of the material it would also be possible to apply the glue by means of cliché rollers, so that the glue C1 is only applied to some of the protuberances of the ply V1, while the glue C2 is only applied to some of the protuberances of the ply V3, different from those below which the glue C1 has been applied. It would also be possible, especially in this second case, for the ply V3 to be omitted, or for the ply V2, V3 to be replaced by a thicker and/or less transparent ply to the plies V1 and V4 or even with one which is totally opaque.

In a further development of the invention, some of the protuberances P1 can be wet with both glues C1, C2 of different colors, to produce a third color, while some protuberances only receive the glue C1 and others only the glue C2, to obtain a product with three colors, where one of the three colors is obtained. by the sum of two primary colors and is visible to a lesser extent through the external plies.

It would also be possible to use one or more colored glues of one or more colors combined with a glue which is colorless or of the same color as the base color of one or of the other plies, which in turn can be colored in the initial pulp, or by printing.

FIG. 18 shows a diagram of a product with three plies (but which can also be produced with a greater number of plies), obtained with a device analogous to the one in FIG. 1, without the gluing unit 7 (or with said gluing unit not operating). The ply V3 is micro-embossed and laminated between cylinder 1 and pressure roller 5. The pressure rollers 3, 4 and 5 have increasing degrees of hardness, so that the ply V1 is embossed more deeply than the ply V2, and the ply V3 is practically only lightly crushed at the level of the protuberances P1, with smoothing out of the micro-embossing in this area. In this way a particularly voluminous product is obtained, thanks to the different depths of embossing of the plies. This can be obtained with different hardnesses of the rollers 3, 4, 5 and/or with different embossing pressures.

The invention can undergo numerous variants, without however departing from the scope of the appended claims. Any reference numbers in the claims are provided purely to facilitate reading thereof in the light of the description and of the drawings and do not in any way limit the scope of protection.

1-40. (canceled)

41. An embossing and laminating device for producing an embossed web material with a plurality of plies glued to one another comprising:
a central embossing cylinder having a plurality of protuberances;
at least three pressure rollers disposed along a periphery of said central embossing cylinder, said at least three pressure rollers each having a yielding surface, and cooperate with said central embossing cylinder;
at least three paths to feed one or more plies between the central embossing cylinder and each of said at least three pressure rollers;
at least a first gluing unit disposed between two consecutive pressure rollers of said at least three pressure rollers and cooperating with said central embossing cylinder.

42. Device as claimed in claim 41, further comprising at least a second gluing unit cooperating with said central embossing cylinder.

43. Device as claimed in claim 42, wherein said first gluing unit and said second gluing unit are each disposed between two respective consecutive pressure rollers of said at least three pressure rollers.

44. Device as claimed in claim 41, wherein a respective gluing unit of said at least a first gluing unit is disposed between each consecutive pair of pressure rollers of said at least three pressure rollers, disposed along said central embossing cylinder.

45. Device as claimed in claim 42, wherein a respective gluing unit of said at least a first gluing unit is disposed between each consecutive pair of pressure rollers of said at least three pressure rollers, disposed along said central embossing cylinder.

46. Device as claimed in claim 43, wherein a respective gluing unit of said at least a first gluing unit is disposed between each consecutive pair of pressure rollers of said at least three pressure rollers, disposed along said central embossing cylinder.

47. Device as claimed in claim 41, further comprising at least one secondary embossing unit, each said at least one secondary embossing unit comprising an embossing cylinder and a pressure roller cooperating therewith, to emboss one or more of said plies upstream of the central embossing cylinder.

48. Device as claimed in claim 47, wherein one of said at least one secondary embossing unit is upstream of each of said at least three pressure rollers.

49. Device as claimed in claim 47, wherein said at least one secondary embossing unit has patterns constituted by geometric distributions and protuberances.

50. Device as claimed in claim 49, wherein said at least one secondary embossing unit imparts embossings with different densities on the plies fed therethrough.

51. Device as claimed in claim 41, wherein at least one of said at least a first gluing unit contains a colored glue.

52. Device as claimed in claim 51, wherein at least two of said at least a first gluing unit contain colored glues of different colors.

53. Device as claimed in claim 41, wherein at least one of said at least a first gluing unit comprise cliché gluing rollers to apply glue in areas phased with the protuberances of said central embossing cylinder.

54. Device as claimed in claim 52, wherein said at least two of said at least a first gluing unit comprise cliché gluing rollers to apply the colored glues of different colors to form with said protuberances patterns of several colors.

55. Method for producing a web material formed by a plurality of plies embossed and joined by gluing, comprising:
feeding at least three plies about a central embossing cylinder having protuberances and cooperating with at least three pressure rollers;
embossing said at least three plies with a common embossing pattern created by said protuberances by passing at least a first ply of said at least three plies through a nip between said central embossing cylinder and a first pressure roller of said at least three pressure rollers, at least said first ply and a second ply of said at least three plies through a nip between said central embossing cylinder and a second pressure roller of said at least three pressure rollers, and at least said first ply, said second ply and a third ply of said at least three plies between a nip between said central embossing cylinder and a third pressure roller of said at least three pressure rollers,
applying to projections formed by said protuberances on at least one of said at least three plies a first glue to join at least two of said plies to one another.

56. Method as claimed in claim 55, wherein a second glue is applied to one of said plies.

57. Method as claimed in claim 56, wherein said first glue and said second glue are applied to two separate plies.

58. Method as claimed in claim 55, wherein said first glue is applied to a ply passing between the first pressure roller and said second pressure roller and to a further ply passing between said second pressure roller and said third pressure roller.

59. Method as claimed in claim 55, wherein two plies not yet embossed by said central embossing cylinder are fed simultaneously into a nip between one of said pressure rollers and the central embossing cylinder and wherein said two plies fed simultaneously are joined by seepage of glue through at least one of said two plies.

60. Method as claimed in claim 56, wherein said first glue and said second glue have colors which differ from each other.

61. Method as claimed in claim 60, wherein one of said first glue and said second glue is colorless and another is colored.

62. Method as claimed in claim 60, wherein both of said first glue and said second glue are colored with colors differing from each other.

63. Method as claimed in claim 60, wherein said first glue and said second glue are applied with cliché gluing rollers to distribute glues of different colors in at least partly separate areas of the web material.

64. Method as claimed in claim 60, wherein said first glue and said second glue of different colors are applied so as to obtain chromatically different decorative patterns on two sides of the web material.

65. Method as claimed in claim 55, wherein said at least three plies are subjected to different embossing depths by said at least three pressure rollers.

66. Method as claimed in claim 55, wherein at least one of said at least three plies is embossed before being fed to said central embossing cylinder.

67. Method as claimed in claim 66, wherein said at least one of said at least three plies is embossed with geometric background embossing.

68. Method as claimed in claim 67, wherein said background embossing has a density equal to or greater than 15 protuberances/cm².

69. Method as claimed in claim 66, wherein at least two of said at least three plies are embossed before being fed to said central embossing cylinder.

70. Method as claimed in claim 69, wherein said at least two of said at least three plies are embossed before being fed to said central embossing cylinder with embossings of different densities.

71. A web product comprising at least three plies joined to one another by gluing and having a common embossing pattern, each ply of said at least three plies having embossing projections defining said common embossing pattern, the embossing projections of said each ply being inserted in corresponding embossing projections of an adjacent ply, and said at least three plies being glued to one another by glue present on at least some of said corresponding embossing projections in said at least three plies, wherein said at least three plies are joined by at least two glues of different colors.

72. A web product comprising at least three plies joined to one another by gluing and having a common embossing pattern, each ply of said at least three plies having embossing projections defining said common embossing pattern, the embossing projections of said each ply being inserted in corresponding projections of an adjacent ply, and said at least three plies being glued to one another by glue present on at least some of said corresponding projections in said at least three plies, wherein a first glue is present at least between two adjacent plies of a first pair of plies of said at least three plies, and a second glue is present at least between two adjacent plies of a second pair of plies of said at least three plies.

73. Product as claimed in claim 70, comprising at least four plies.

74. Product as claimed in claim 71, comprising at least four plies.

75. Product as claimed in claim 72, wherein said at least three plies are joined to one another by at least one colored glue.

76. Product as claimed in claim 71, wherein said at least two glues of different colors are present in areas at least partly separate from one another to produce decorative patterns of several colors.

77. Product as claimed in claim 71, wherein said at least two glues of different colors define chromatically different decorative patterns on two sides of the web product.

78. Product as claimed in claim 71, wherein at least two of said at least three plies have embossments of different depths.

79. Product as claimed in claim 71, wherein at least one of said at least three plies has a background embossing pattern in addition to said common embossing pattern.

80. Product as claimed in claim 79, wherein at least two of said at least three plies have said background embossing pattern.

81. Product as claimed in claim 80, wherein the background embossing pattern of said at least two of said at least three plies have different densities.

82. Product as claimed in claim 80, wherein said background embossing pattern has a density equal to or greater than 15 protuberances/cm².
